(19) United States
(12) Patent Application Publication
(10) Pub. No.: US 2026/0290014 A1
(43) Pub. Date: Sep. 24, 2026

(54) Edge Event Driven Camera Analysis and Response Systems and Methods

(71) Applicant: Anava, Inc., Weatherby Lake, MO (US)

(72) Inventors: Ryan Wager, Weatherby Lake, MO (US); John B. Fowler, Salt Lake City, UT (US); Matthew J. Ebben, Chandler, AZ (US); Rhett R. Place, Overland Park, KS (US); Daniel S. Davidson, Gladstone, MO (US); Ryan J. Echols, Weatherby Lake, MO (US)

(21) Appl. No.: 19/572,745

(22) Filed: Mar. 19, 2026

Related U.S. Application Data
(60) Provisional application No. 63/775,900, filed on Mar. 21, 2025.
(60) Provisional application No. 63/775,996, filed on Mar. 21, 2025.
(60) Provisional application No. 63/775,905, filed on Mar. 21, 2025.

(51) Int. Cl. G06V 20/40; G06F 16/532; G06V 10/25; G06V 10/26; G06V 10/764; G06V 20/52; G06V 40/16; G10L 13/027; H04N 7/18; H04N 19/46

(52) U.S. Cl. CPC G06V 20/44; G06F 16/532; G06V 10/25; G06V 10/26; G06V 10/764; G06V 20/41; G06V 20/46; G06V 20/52; G06V 40/166; G10L 13/027; H04N 7/183; H04N 19/46

(57) ABSTRACT

A camera-resident edge processing architecture consumes kernel metadata events from a built-in sensor subsystem, extracts event-correlated keyframes, and prepares compressed payloads with region-focused and temporal tiling options for remote model analysis. Structured prompt payloads and image payloads are dispatched to remote artificial intelligence services through detached query threads with conditional escalation based on a first-pass gate outcome. Parsed response fields are normalized into structured response records with event classifications driving automated response execution, including external event publication and contextual local speech output. Feedback records from response processing update trigger criteria for later event qualification cycles, enabling iterative precision tuning across repeated monitoring operations while reducing unnecessary upstream transfer and high-cost remote processing.

### CROSS-REFERENCE TO RELATED APPLICATIONS

This application claims the benefit and priority of U.S. Provisional Application Ser. No. 63/775,900, filed on Mar. 21, 2025, of U.S. Provisional Application Ser. No. 63/775,996, filed on Mar. 21, 2025, and of U.S. Provisional Application Ser. No. 63/775,905, filed on Mar. 21, 2025, each of which are each hereby incorporated by reference herein in their entireties, including all references and appendices cited therein for all purposes, as if fully set forth herein.

This application is related to United States Patent Application Serial Number X, filed on Mar. 19, 2026, entitled “SYSTEM AND METHOD FOR GENERATING AND ANALYZING METADATA FROM LIVE VIDEO STREAMS USING AN ON-CAMERA AGENTIC APPLICATION AND SERVERLESS CLOUD BACKEND,” which is herein incorporated by reference herein in its entirety, including all references and appendices cited therein for all purposes, as if fully set forth herein.

### FIELD

This patent relates generally to edge-deployed agentic applications for camera-based physical security systems, and more particularly to systems and methods for kernel-level object detection, event detection, and event generation on live camera streams through integration of edge-resident firmware applications with cloud-based artificial intelligence services for real-time multi-pass image analysis, automated response execution, and structured event communication.

### BACKGROUND

Video surveillance systems have conventionally relied on continuous transmission of full-resolution video streams from camera devices to centralized compute infrastructure, including dedicated server hardware and graphics processing unit arrays. This approach requires persistent high-bandwidth network connections between each camera device and the analysis facility, and incurs ongoing infrastructure costs proportional to the number of deployed cameras regardless of whether monitored scenes contain activity warranting analysis. Deployments spanning large numbers of cameras compound these costs and create processing bottlenecks at centralized analysis nodes that limit the responsiveness of event detection and response execution.

Conventional event detection pipelines process raw video frames arriving in continuous sequence, applying analysis uniformly across all frames without regard to whether object detection or motion signals indicate that the current scene content warrants examination. When a detection condition is satisfied, conventional systems commonly transmit the full scene frame to remote analysis infrastructure rather than limiting the transmitted image to the localized region corresponding to the detected object. This over-transmission of scene data that is not relevant to the detected condition consumes network capacity, increases storage requirements for transmitted payloads, and introduces transmission latency that delays subsequent response execution.

Conventional analysis orchestration invokes analysis resources at a cost proportional to the volume and complexity of submitted queries, without differentiating between routine events that are unlikely to require detailed examination and conditions that warrant costly advanced analysis. A call-center operator or automated system receiving undifferentiated object detection notifications encounters both routine occurrences, such as a person traversing a retail environment, and conditions warranting intervention, such as unauthorized access during restricted hours. Without an automated preliminary assessment layer that filters low-significance events before invoking high-cost analysis resources, large camera fleets generate volumes of routine events that overwhelm manual review capacity and consume computational resources on conditions that do not require detailed analysis.

Conventional surveillance output pathways produce alert payloads that are not normalized to machine-readable structured formats with declared typed fields, complicating automated downstream action logic that parses variable and inconsistent alert structures before responses can be executed. Response execution frequently depends on human operators who receive notifications, assess scene context manually, and initiate deterrence actions such as verbal warnings through on-site audio systems. The interval between event occurrence and effective human response typically spans several minutes, substantially reducing deterrence efficacy for time-sensitive security incidents in which rapid on-site intervention determines outcome.

### SUMMARY

In one aspect, a system includes a camera device including a built-in sensor subsystem configured to generate kernel metadata events and a video stream, an edge event listener resident in the camera device and configured to read the kernel metadata events from an event buffer, a keyframe extraction module resident in the camera device and configured to read video frames from the video stream and write keyframe records to a keyframe buffer responsive to the kernel metadata events satisfying trigger criteria, an adaptive compression module resident in the camera device and configured to read the keyframe records and bounding-box coordinates included in the kernel metadata events and write compressed image payloads to a transmission queue, a query dispatch module configured to read the compressed image payloads and structured prompt payloads from the transmission queue and transmit first query messages to a first remote artificial intelligence model through a network interface, an escalation module configured to parse first model responses and conditionally transmit second query messages to a second remote artificial intelligence model based on a binary gate field, a response parser configured to parse second model responses and write structured response records including event-classification fields to a response data structure, and an automated response module configured to read the structured response records from the response data structure and execute output actions.

In one aspect, a method includes receiving, by an edge event listener resident in a camera device, kernel metadata events from a built-in sensor subsystem into an event buffer, reading, by a keyframe extraction module resident in the camera device, video frames from a video stream and writing keyframe records to a keyframe buffer responsive to the kernel metadata events satisfying trigger criteria, reading, by an adaptive compression module resident in the camera device, the keyframe records and bounding-box coordinates included in the kernel metadata events and writing compressed image payloads to a transmission queue, reading, by a query dispatch module, the compressed image payloads and structured prompt payloads from the transmission queue and transmitting first query messages to a first remote artificial intelligence model through a network interface, receiving first model responses and conditionally transmitting second query messages to a second remote artificial intelligence model based on a binary gate field, parsing second model responses and writing structured response records including event-classification fields to a response data structure, and reading the structured response records from the response data structure and executing output actions.

In one aspect, a video surveillance system includes a camera device including a built-in sensor subsystem configured to generate kernel metadata events and a video stream, an edge event listener resident in the camera device and configured to read the kernel metadata events from an event buffer, an object and event detection module resident in the camera device and configured to interface with one or more external artificial intelligence services to detect and classify objects and events in the video stream, a keyframe extraction and adaptive compression module resident in the camera device and configured to read video frames from the video stream and write compressed image payloads to a transmission queue using bounding-box coordinates included in the kernel metadata events, a query dispatch module configured to transmit first query messages to a first remote artificial intelligence model, an escalation module configured to parse first model responses and conditionally transmit second query messages to a second remote artificial intelligence model based on a binary gate field, a response parser configured to parse second model responses and write structured response records including event-classification fields to a response data structure, and an event generation module configured to read the structured response records from the response data structure and generate events including encoding overlay metadata onto the video stream and transmitting structured event messages to one or more downstream network-connected devices.

Additional implementations include region-of-interest cropping before queue write operations, temporal tiled payload generation with sequence-order metadata, concurrent detached query thread dispatching to multiple remote artificial intelligence models, feedback-loop trigger refinement from response-derived records, publication to external event buses through interoperable event protocols, contextual speech generation with local audio output streaming, cloud-based facial recognition with overlay data encoding onto the video stream, and trigger signal transmission to access control devices and alarm systems based on event-classification field values.

### BRIEF DESCRIPTION OF THE DRAWINGS

FIG. 1 is a system architecture view of edge-resident event detection, object and event detection, event generation, adaptive image preparation, remote model analysis, and automated response generation.

FIG. 2 is a trigger-to-action process flow showing event qualification, frame handling, query dispatch, response parsing, and action execution.

FIG. 3 is a region-of-interest processing detail view showing event-indicated cropping, optional multi-region selection, and compressed payload production.

FIG. 4 is a hierarchical model escalation logic view showing first-pass gate evaluation and conditional routing to advanced analysis.

FIG. 5 is a multi-frame tiling arrangement view showing ordered keyframes, layout mapping, sequence metadata association, and composite payload emission.

FIG. 6 is an automated contextual audio response path view showing parsed attributes, template selection, text generation, voice synthesis, and local audio output.

FIG. 7 is a schematic diagram of an example computer system that can be used to implement aspects of the present disclosure.

### DETAILED DESCRIPTION OF EXAMPLE EMBODIMENTS

According to some embodiments, the disclosed architecture implements a camera-resident event-conditioned analysis and response pipeline using a camera device that includes a built-in sensor subsystem configured to generate kernel metadata events and a continuous video stream. An edge event listener, a keyframe extraction module and adaptive compression module, a query dispatch module, an escalation module and response parser, and an automated response module reside as firmware-deployed software components within the camera device. In some embodiments, the firmware-deployed software components are implemented as a compiled binary application using an Access Camera Application Platform (ACAP) framework that is directly embedded within the camera device's firmware, enabling kernel-level event monitoring and direct sensor interactions without requiring external server infrastructure. A first remote artificial intelligence model, external sensors, a plurality of application programming interface (API) feature links, and external event and data systems interact with the camera device across a network interface to provide remote analysis and downstream event routing capabilities.

The processor and memory of the camera device store and execute the firmware instructions that implement each module's operations. The built-in sensor subsystem includes an application-specific integrated circuit (ASIC) that monitors the video stream and generates kernel metadata events when predefined object classes are detected, including human figures, vehicles, and faces. Each kernel metadata event carries an object class identifier, a timestamp, and bounding-box coordinates defining the rectangular region within the video frame where the detected object is located. These kernel metadata events serve as the primary triggering gate for the analysis pipeline, allowing the edge event listener to condition all downstream processing on hardware-confirmed object detection rather than continuous software-level frame analysis. In some embodiments, the keyframe extraction module and adaptive compression module 106 extracts image frames directly from the ASIC chipset at a kernel or near-hardware level prior to codec encoding or compression, preserving full image fidelity and optimizing bandwidth usage by operating on uncompressed source data before any lossy encoding is applied.

Kernel metadata events generated by the built-in sensor subsystem carry object condition outputs and bounding-box coordinate sets that are delivered to the edge event listener as each event is written to the event buffer. The edge event listener evaluates incoming kernel metadata events against a set of configurable trigger criteria before signaling the keyframe extraction module and adaptive compression module to initiate frame extraction. Trigger criteria can include object class filters specifying one or more target object classes, persistence thresholds requiring that a qualifying object remain detectable for a minimum duration, schedule state filters restricting processing to defined time windows, and supplementary context signals from external sensors that are concurrently satisfied before event qualification advances to frame extraction.

When trigger criteria are satisfied, the keyframe extraction module and adaptive compression module extracts one or more keyframes from the video stream corresponding to the qualifying event interval, applies bounding-box-informed adaptive cropping using the object coordinate boundary data from the kernel metadata event to isolate the event-relevant image region, and writes a compressed image payload to a transmission queue. The query dispatch module reads compressed image payloads and structured prompt payloads from the transmission queue and transmits first query messages to the first remote artificial intelligence model through the network interface. Applying bounding-box-informed adaptive cropping before transmission reduces raw frame sizes from approximately ten megabytes to as low as twenty kilobytes, substantially reducing bandwidth consumption and round-trip latency for remote model queries.

Representative trigger criteria applied by the edge event listener include persistence of detected human presence in a designated restricted zone for a configured minimum duration, such as ten seconds, and motion detection within a defined zone during off-hours schedule windows. Threshold algorithms adjust detection sensitivity based on environmental conditions; for example, increasing motion detection thresholds during periods of elevated ambient motion, such as wind-driven vegetation movement, reduces false-positive event qualification. External sensor inputs, including audio sensors and environmental sensors, can be fused with kernel metadata event data to require concurrent satisfaction of both an object detection condition and a contextual sensor condition before an event is qualified for keyframe extraction.

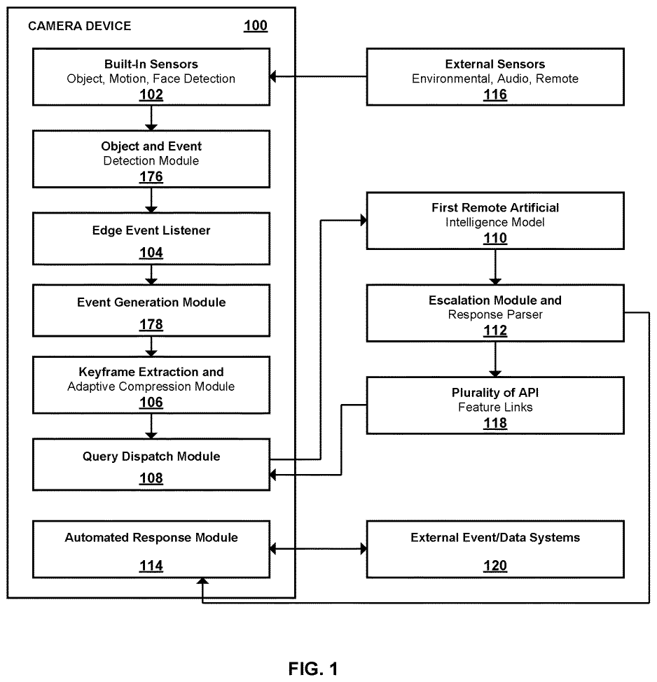

Referring now to FIG. 1, the camera device 100 includes a built-in sensor subsystem 102 configured to generate kernel metadata events and a video stream. The built-in sensor subsystem 102 includes ASIC hardware components that monitor the video stream and generate kernel metadata events when predefined object classes are detected, including human figures, vehicles, and faces. Each kernel metadata event carries an object class identifier, a timestamp, and bounding-box coordinates defining the rectangular region within the corresponding video frame where the detected object is located. These bounding-box coordinates are propagated downstream to the keyframe extraction module and adaptive compression module 106, enabling region-focused image preparation without requiring the edge event listener 104 to perform software-level image analysis.

The edge event listener 104 is resident in the camera device 100 and configured to read kernel metadata events from an event buffer and evaluate trigger criteria. The edge event listener 104 subscribes to the kernel metadata event stream produced by the built-in sensor subsystem 102 and receives event records as the built-in sensor subsystem 102 writes them to the event buffer. Each event record is evaluated against a set of configurable trigger criteria before the edge event listener 104 signals the keyframe extraction module and adaptive compression module 106 to initiate extraction. Trigger criteria can be updated at runtime through feedback records written to a rule store by the escalation module and response parser 112, enabling iterative precision refinement across repeated monitoring cycles without firmware redeployment.

The keyframe extraction module and adaptive compression module 106 is resident in the camera device 100 and configured to read video frames from the video stream and write keyframe records to a keyframe buffer responsive to kernel metadata events satisfying trigger criteria. Upon receiving a qualified event signal from the edge event listener 104, the keyframe extraction module and adaptive compression module 106 selects one or more video frames from the video stream that capture the qualifying event interval. In some embodiments, the keyframe extraction module and adaptive compression module 106 retrieves a configurable number of frames preceding the event timestamp to provide pre-event scene context alongside the event-moment frame, supporting temporal analysis of the sequence leading to the qualifying condition.

The keyframe extraction module and adaptive compression module 106 is further configured to read keyframe records and bounding-box coordinates included in the kernel metadata events and write compressed image payloads to a transmission queue. The keyframe extraction module and adaptive compression module 106 applies bounding-box-informed adaptive cropping by constraining the extracted image to the pixel area defined by the bounding-box coordinates, with an optional configurable margin added around the boundary to ensure the full detected subject is captured, and clips the cropping region to the input frame boundary to prevent out-of-bounds coordinate references. The cropped region is encoded into a compressed image format suitable for network transmission, reducing transmitted payload size substantially relative to full-resolution frame transmission.

The query dispatch module 108 is configured to read compressed image payloads and structured prompt payloads from the transmission queue and transmit first query messages to a first remote artificial intelligence model 110 through a network interface. The query dispatch module 108 conducts error checking on outbound transmissions and utilizes multi-threading for rapid and reliable data delivery, ensuring optimal transfer of information to configured remote service endpoints. The query dispatch module 108 assembles each first query message by combining a compressed image payload with a structured prompt payload encoding event context, requested output schema, and any sequence-order metadata associated with composite tiled image payloads. The query dispatch module 108 supports concurrent detached thread dispatch, launching multiple independent threads that simultaneously transmit query messages to distinct configured remote service endpoints through the plurality of API feature links 118, including artificial intelligence analysis endpoints such as Gemini, OpenAI ChatGPT, Grok, and DeepSeq, cloud storage endpoints such as Google Cloud Storage, facial recognition endpoints, and voice synthesis endpoints such as ElevenLabs for text-to-speech conversion and Twilio for Short Message Service (SMS) alert delivery. The query dispatch module 108 includes selection logic that applies predefined rules and thresholds to determine the most appropriate remote service endpoint for each event type, ensuring that, for example, loitering events are routed to a behavioral analytics endpoint and facial recognition triggers are routed to a dedicated facial recognition service endpoint.

The escalation module and response parser 112 is configured to parse first model responses from the first remote artificial intelligence model 110 and, when a gate field selected from 0 and 1 is 1, transmit second query messages to a second remote artificial intelligence model through the plurality of API feature links 118. The first remote artificial intelligence model 110 is a low-cost model configured to receive a minimal query payload and return a binary gate field indicating whether the event warrants detailed analysis. By limiting the first query message to a single binary question, the query payload and response payload are kept to minimum token counts, reducing the per-query cost of the first-pass gate to a small fraction of the per-query cost of a full multi-field structured analysis query.

The escalation module and response parser 112 is further configured to parse second model responses and write structured response records including event-classification fields to a response data structure. The second remote artificial intelligence model receives a multi-field structured prompt specifying a plurality of named output fields with declared data types and returns a machine-parseable structured response in which each requested field is populated with a typed value. The escalation module and response parser 112 parses each named field by declared data type, validates the parsed field set against the expected schema, and writes a normalized structured response record to the response data structure that includes event-classification fields, subject descriptors, behavioral classifications, and zone identifiers.

The automated response module 114 is configured to read structured response records from the response data structure and execute output actions, including publication to external event and data systems 120 and local audio output routing. The automated response module 114 maps event-classification field values and subject descriptors from the structured response record to configurable response policies. For events warranting audio deterrence, the automated response module 114 generates contextual speech text that references specific visual details from the parsed response fields, transmits the speech text to a voice synthesis interface, and delivers the resulting audio output stream to a local audio output interface connected to the camera device 100 within milliseconds of event detection. Additionally, the automated response module 114 can transmit SMS alert messages to security personnel via a messaging application programming interface, such as the Twilio API, for high-priority events, and can log event records including event classification, timestamp, and zone identifier values to an event database for subsequent review, audit, and historical analysis of lower-priority events.

The plurality of API feature links 118 supports detached query thread routing to multiple remote analysis and storage endpoints, with each endpoint assigned a distinct authentication profile that the query dispatch module 108 applies during message dispatch. Authentication profiles support Open Authorization (OAuth) token-based schemes and API key schemes, providing compatibility with a broad range of remote service providers. In some embodiments, the plurality of API feature links 118 includes a configuration interface through which users specify remote service endpoint addresses and authentication credentials, the configuration interface comprising a user interface with input fields for an application programming interface uniform resource locator (URL) and an application programming interface key, or alternatively a configuration file that can be updated to add additional remote service endpoints with minimal code adjustments limited to updating the URL and authentication logic. The plurality of API feature links 118 allows the query dispatch module 108 to route first query messages to a low-cost gate model endpoint and, upon escalation, route second query messages to a distinct higher-cost analysis model endpoint, maintaining separation between gate workloads and full-analysis workloads at the service routing layer. The plurality of API feature links 118 utilizes standardized protocols and data interchange formats including JavaScript Object Notation (JSON), Extensible Markup Language (XML), and Representational State Transfer (RESTful) application programming interface protocols, and supports Open Network Video Interface Forum (ONVIF)-compliant interfaces ensuring seamless interoperability and integration with existing video management software (VMS) and third-party surveillance ecosystem components.

External sensors 116 provide supplementary context signals to the edge event listener 104 for use during trigger criteria evaluation. External sensors 116 can include environmental sensors measuring conditions such as temperature and ambient light level, audio sensors detecting sound events such as glass breakage or raised voices, and auxiliary detection devices providing perimeter state information. The edge event listener 104 fuses external sensor 116 signals with kernel metadata event data, allowing trigger criteria to require concurrent satisfaction of both hardware object detection and contextual sensor conditions before an event is qualified for keyframe extraction.

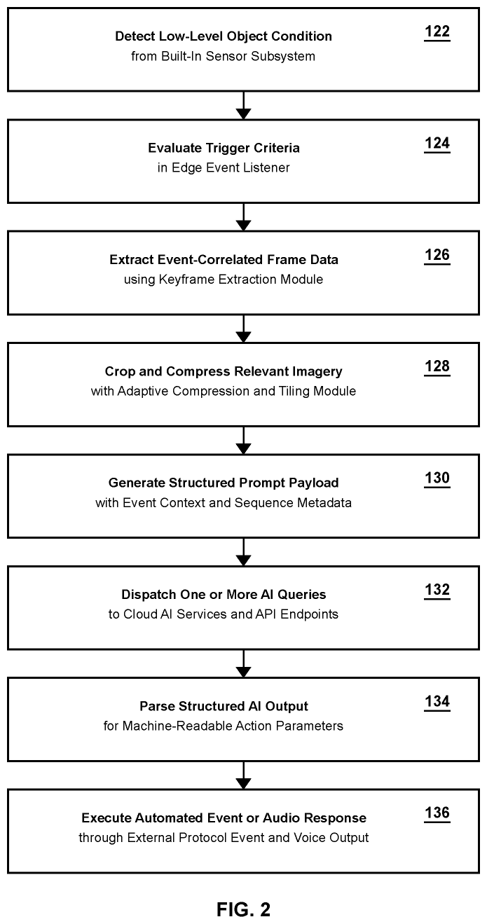

As shown in FIG. 2, low-level object condition detection step 122 receives kernel metadata events from the built-in sensor subsystem 102 into an event buffer. The built-in sensor subsystem 102 generates kernel metadata events at the hardware level through the embedded ASIC when predefined object classes are detected in the video stream, delivering each event record carrying an object class identifier, timestamp, and bounding-box coordinates to the event buffer as the detection occurs. Low-level object condition detection step 122 does not require software-level video frame processing because the ASIC hardware performs object classification and coordinate extraction before writing the event record to the event buffer.

Trigger criteria evaluation step 124 reads event buffer content and applies configured trigger criteria to each incoming kernel metadata event. The configured trigger criteria specify one or more conditions that a kernel metadata event satisfies before pipeline processing advances to keyframe extraction, including object class membership, minimum persistence duration, schedule state, and optional contextual sensor state requirements from external sensors 116. When all conditions of the trigger criteria are satisfied, trigger criteria evaluation step 124 signals event-correlated frame extraction step 126 to initiate keyframe extraction. When conditions are not satisfied, the event record is discarded and the edge event listener 104 returns to monitoring the event buffer.

Event-correlated frame extraction step 126 reads video frames from the video stream and writes keyframe records to a keyframe buffer responsive to kernel metadata events satisfying trigger criteria. Event-correlated frame extraction step 126 uses the timestamp from the qualifying kernel metadata event to select the video frame or set of video frames that best captures the event interval. In some embodiments, event-correlated frame extraction step 126 retrieves a configurable number of frames preceding the event timestamp to provide pre-event scene context alongside the event-moment frame, enabling temporal analysis of the sequence leading to the qualifying condition.

Region-of-interest crop and adaptive compression step 128 reads keyframe records and bounding-box coordinates included in the kernel metadata events and writes compressed image payloads to a transmission queue. Region-of-interest crop and adaptive compression step 128 uses the bounding-box coordinates to define the cropping boundary, applies an optional configurable margin around the boundary to ensure the full detected subject is captured, and clips the crop region to the input frame boundary 138 to prevent out-of-bounds coordinate references. The cropped image region is then encoded using a selected compression profile, generating a compressed image payload that retains event-relevant visual content while substantially reducing file size relative to the full-resolution source frame.

Structured prompt payload generation step 130 assembles structured prompt payloads including event context and sequence-order metadata for inclusion with first query messages and second query messages. The structured prompt payload specifies requested output field names, declared data types for each requested field, event context identifiers, and, when a composite tiled image payload is used, sequence-order metadata encoding the number of frames in the composite, the inter-frame interval, and the reading direction of the tile arrangement. In some embodiments, structured prompt payload generation step 130 compiles prompt content from user-defined natural language criteria that specify event detection conditions and requested analysis dimensions, enabling operators to define policy intent without authoring machine-formatted query strings.

Artificial intelligence query dispatch step 132 reads compressed image payloads and structured prompt payloads from the transmission queue and transmits first query messages to the first remote artificial intelligence model 110 through a network interface. Artificial intelligence query dispatch step 132 launches each outbound query as a detached thread, allowing multiple concurrent query threads to execute simultaneously without blocking the main event processing loop. This concurrent dispatch architecture allows the edge event listener 104 to continue evaluating incoming kernel metadata events from the event buffer while outstanding query threads await responses from remote model endpoints, maintaining pipeline throughput during response latency intervals.

Structured artificial intelligence output parsing step 134 parses first model responses and, upon escalation, second model responses, and writes structured response records including event-classification fields to a response data structure. When a first model response carries a gate field value of 1, structured artificial intelligence output parsing step 134 constructs and dispatches a second query message to the second remote artificial intelligence model before parsing the resulting second model response. The second model response is parsed field by field according to the declared data types specified in the structured prompt payload, and the resulting parsed field values are assembled into a normalized structured response record including event-classification fields, subject descriptors, behavioral classifications, and zone identifiers.

Structured artificial intelligence output parsing step 134 also writes a feedback record to a rule store, and the edge event listener 104 reads the feedback record from the rule store to update trigger criteria before subsequent trigger criteria evaluation step 124 cycles. Feedback records can include false-positive indicators generated when parsed response fields indicate that a qualified event did not warrant intervention, event class corrections identifying misclassifications, and threshold adjustment directives modifying the persistence duration or object class membership requirements in the stored trigger criteria. The edge event listener 104 applies feedback-driven trigger criteria updates to reduce recurring non-actionable event qualification while preserving event capture behavior for high-priority event classifications.

Automated event or audio response execution step 136 reads structured response records from the response data structure and executes output actions through the automated response module 114. The automated response module 114 selects a response pathway from the configured response policies based on the event-classification field value and subject descriptor fields in the structured response record. High-classification structured response records can trigger concurrent execution of multiple response pathways, including local audio output through the voice synthesis interface and publication of a structured event message to an external event bus, within the same response execution cycle. For example, when the escalation module and response parser 112 writes a structured response record with a behavioral classification of “theft in progress” and an associated confidence score exceeding 0.8, the automated response module 114 triggers a loud alarm through a speaker connected to the camera device 100 and simultaneously transmits an SMS alert to designated security personnel, whereas for lower-severity event classifications such as loitering, the automated response module 114 logs the event record in an event database for subsequent review without triggering an immediate alarm.

Output actions executed by automated event or audio response execution step 136 include publication of an event message including an event classification to an external event bus using an interoperable event protocol, and transmission of an audio output stream to a local audio output interface. The event message includes the event classification value, escalation status, event identifier, and zone identifier derived from the parsed structured response record fields, providing downstream systems with a normalized event record for dashboard rendering, archival storage, and automated orchestration. The audio output stream is generated by transmitting contextual speech text derived from parsed subject descriptor fields to a voice synthesis interface that converts the text to synthesized speech for delivery through a speaker connected to the camera device 100.

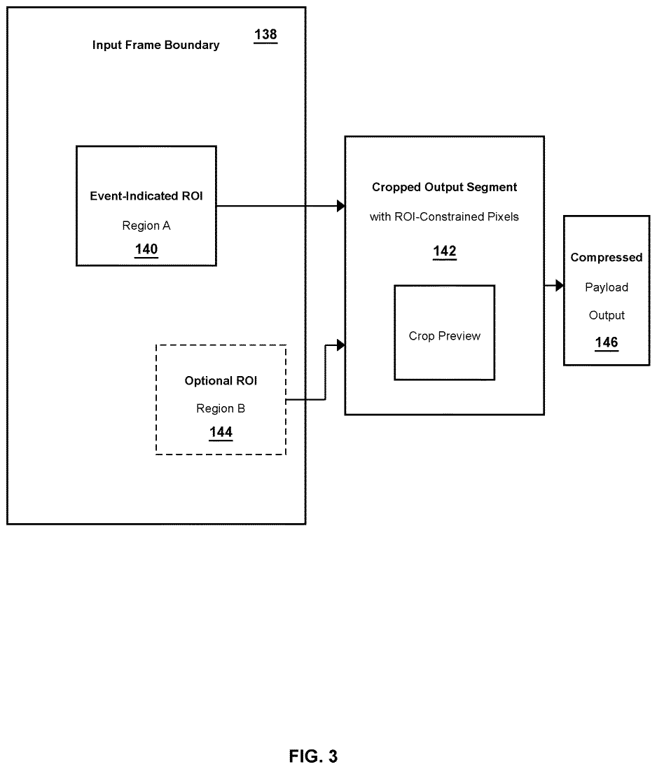

In FIG. 3, input frame boundary 138 represents the full spatial extent of a source video frame captured from the video stream of the camera device 100 during event-conditioned preprocessing. The input frame boundary 138 defines the maximum coordinate space within which bounding-box coordinate values from the built-in sensor subsystem 102 are valid, and serves as a clipping boundary applied by region-of-interest crop and adaptive compression step 128 to prevent out-of-bounds crop operations when bounding-box coordinates received with margin expansion values would otherwise exceed the frame edge.

Event-indicated region of interest 140 is derived from bounding-box coordinates carried by kernel metadata events generated by the built-in sensor subsystem 102. The four coordinate values in the bounding-box data define a rectangular crop region within the input frame boundary 138 that encompasses the detected object. In some embodiments, a configurable margin is added uniformly around the bounding-box boundary before the crop operation, expanding the event-indicated region of interest 140 to include a surrounding context zone while the overall crop region is clipped to remain within the input frame boundary 138.

Cropped output segment 142 is generated by extracting the event-relevant pixel region from the input frame boundary 138 using the event-indicated region of interest 140 coordinate boundary. The cropped output segment 142 contains the pixels within the event-indicated region of interest 140, discarding background scene content outside the object boundary. This selective extraction reduces image payload size from the approximately ten-megabyte raw video frame to a compressed payload of approximately twenty kilobytes or less, depending on the size of the event-indicated region of interest 140 relative to the full frame and the selected compression encoding profile.

Optional multi-region selection 144 supports concurrent extraction of additional event-relevant regions when a kernel metadata event or scene conditions indicate that multiple objects or subjects are present within the frame and warrant simultaneous analysis. When optional multi-region selection 144 is active, the keyframe extraction module and adaptive compression module 106 generates multiple cropped output segments from a single source keyframe, each corresponding to a distinct bounding-box region. Each cropped output segment can be included in a separate concurrent query thread dispatched through the plurality of API feature links 118 to the appropriate analysis endpoint.

Compressed payload output 146 is generated from the cropped output segment 142, or from tiled content assembled from multiple sequential cropped keyframes according to transmission constraints and quality targets. The keyframe extraction module and adaptive compression module 106 selects a compression encoding profile based on the target endpoint format requirements, the available network bandwidth, and the configured image quality floor. Compressed payload output 146 is written to the transmission queue for retrieval by the query dispatch module 108. In some embodiments, compressed payload output 146 supports Cinemascope video format compatibility, accommodating ultra-wide aspect ratio video streams having aspect ratios of 2.35:1 or 2.39:1 that are used in high-definition surveillance scenarios, and the keyframe extraction module and adaptive compression module 106 selectively processes keyframes within the Cinemascope format to reduce transmitted data volume while preserving salient visual details across the wider field of view.

Adaptive compression operations applied by region-of-interest crop and adaptive compression step 128 include coordinate normalization to convert ASIC-provided bounding-box coordinate values to the pixel coordinate space of the extracted video frame, optional margin expansion around the event-indicated region of interest 140, boundary clipping to the input frame boundary 138, and encoding profile selection based on configured output format requirements. These operations collectively produce a compressed payload output 146 that retains the event-relevant visual content of the cropped output segment 142 while meeting transmission size and format targets.

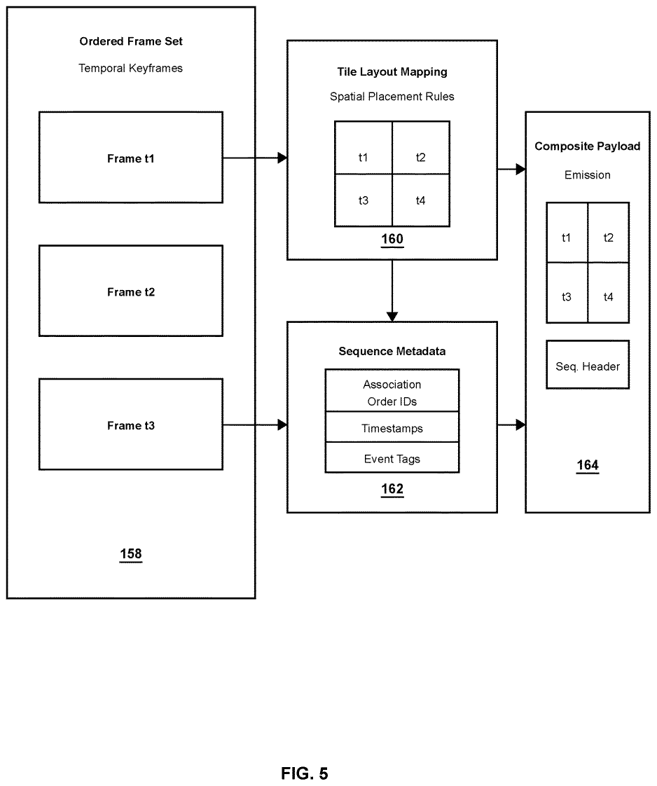

Temporal frame tiling pathways preserve scene sequence context by aggregating multiple sequential cropped keyframes into a single composite tiled image payload, as further described in connection with FIG. 5. Transmitting multiple event-interval frames as a single composite tiled image reduces the number of separate API calls used to convey scene progression to the remote artificial intelligence model, lowering per-event query cost and reducing aggregate round-trip latency compared to issuing separate queries for each sequential frame in the event interval.

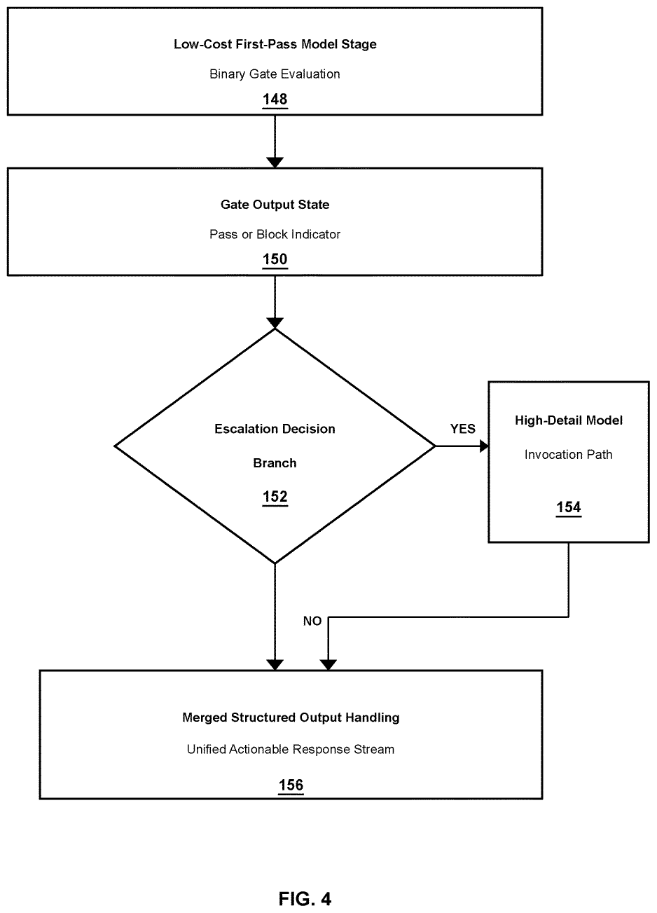

In FIG. 4, low-cost first-pass model stage 148 receives first query messages assembled by the query dispatch module 108 and returns a gate output state 150 representing a binary gate field. The first remote artificial intelligence model 110 operating at low-cost first-pass model stage 148 is configured to evaluate the compressed image payload against a single binary question specifying whether the event-indicated image region presents conditions warranting detailed analysis. This single-question binary format minimizes token count in both the outbound prompt and the inbound response, reducing the per-query cost of the first-pass gate stage to a small fraction of the per-query cost of a full multi-field structured analysis query. In some embodiments, the first remote artificial intelligence model 110 operating at low-cost first-pass model stage 148 comprises a convolutional neural network (CNN) that classifies the event into broad categories such as human presence, vehicle movement, or no significant activity, while the second remote artificial intelligence model operating at high-detail model invocation path 154 comprises a transformer-based network capable of performing detailed contextual analysis including identifying specific actions and recognizing individuals.

Escalation decision branch 152 consumes gate output state 150 and conditionally routes the event processing pipeline to high-detail model invocation path 154 when gate output state 150 carries a value of 1. When gate output state 150 carries a value of 0, escalation decision branch 152 routes the event to merged structured output handling element 156 without invoking the second remote artificial intelligence model, and merged structured output handling element 156 writes a gate-only record to the response data structure that omits the multi-field structured analysis fields. This binary gating architecture ensures that the computational cost and latency associated with full multi-field structured analysis are incurred only for events that the low-cost first-pass model stage 148 has identified as warranting escalated examination.

High-detail model invocation path 154 transmits second query messages to a second remote artificial intelligence model when gate output state 150 indicates escalation. The second query message transmitted through high-detail model invocation path 154 carries the same compressed image payload as the first query message, combined with a multi-field structured prompt specifying a plurality of named output fields including event classification, subject descriptors such as clothing color and article type, behavioral classification, zone identifier, and confidence score. The second remote artificial intelligence model returns a machine-parseable structured response populated with typed values for each requested named field.

Merged structured output handling element 156 normalizes first-pass outputs and second-pass outputs for downstream action processing by the escalation module and response parser 112. The merged structured output handling element 156 assembles a unified record from the gate field value returned by low-cost first-pass model stage 148 and the named field values returned by the second remote artificial intelligence model through high-detail model invocation path 154. This unified record is passed to the structured response record writing logic, which populates the response data structure entry with event-classification fields, subject descriptors, and all other parsed response field values.

Merged structured output handling element 156 can write an escalation marker indicating whether a second query message was dispatched for the current event. The escalation marker value associates a record of whether high-detail model invocation path 154 was triggered with the event identifier in the response data structure, providing an audit trail that identifies which events were resolved by binary gate discard and which events received full multi-field structured analysis. Escalation marker records support operational review of gate accuracy and provide input for threshold adjustment directives in the feedback loop.

Escalation thresholds can be applied using confidence and event-classification parameters in addition to the binary gate field value. In some embodiments, the low-cost first-pass model stage 148 returns a confidence score alongside the binary gate field, and the escalation decision branch 152 routes to high-detail model invocation path 154 when the confidence score exceeds a predefined threshold stored in a threshold configuration record in memory of the camera device 100. This confidence-conditioned escalation path provides an additional routing criterion that can be applied concurrently with or in place of the binary gate field evaluation. For example, a confidence score threshold of 0.7 can be configured for the first-pass gate model, whereby events with a confidence score exceeding 0.7 are escalated to the second remote artificial intelligence model for detailed multi-field structured analysis, and a higher confidence score threshold of 0.8 can be applied at the second-pass stage to determine whether an event classification warrants triggering high-priority automated responses.

In FIG. 5, ordered frame set 158 stores sequential keyframes selected from the video stream around a qualified event interval. The keyframe extraction module and adaptive compression module 106 populates the ordered frame set 158 with a configurable number of sequential cropped keyframes, each capturing a distinct moment within the event interval. The number of frames included in the ordered frame set 158, the inter-frame interval, and the frame capture timing relative to the triggering kernel metadata event are configurable parameters governing how much temporal scene context is preserved in the composite tiled image payload transmitted to the remote artificial intelligence model.

Tile layout mapping 160 arranges sequential keyframes from the ordered frame set 158 in deterministic tile positions within a composite image canvas. The tile layout mapping 160 assigns each frame to a fixed position in the composite image grid based on the frame's sequence order within the event interval, so that the spatial position of each tile within the composite image corresponds to its temporal position in the sequence. The tile layout mapping 160 defines the grid dimensions and reading direction of the tile arrangement, and this layout specification is encoded in the structured prompt payload transmitted with the composite tiled image payload to instruct the remote artificial intelligence model on the correct interpretation of the tile arrangement. In some embodiments, the tile layout mapping 160 divides each keyframe image into a grid, such as a four-by-four tile grid, and each tile is individually analyzed for changes between consecutive frames, whereby tiles with significant changes are preserved at higher quality while static tiles are downsampled or compressed more aggressively, ensuring that event-relevant details are retained while reducing overall transmitted data size through content-adaptive compression at the tile level.

Sequence metadata association 162 binds sequence-order metadata to tile positions and event identifiers within the structured prompt payload. Sequence-order metadata encoded by sequence metadata association 162 includes the total frame count in the composite image, the inter-frame interval in milliseconds, the reading direction of the tile sequence, and the event identifier linking the composite tiled image payload to the originating kernel metadata event. This metadata enables the remote artificial intelligence model to interpret the composite image as a temporal sequence of scene states rather than a static multi-region image, supporting behavioral analysis across the event interval.

Composite payload emission 164 outputs a composite tiled image payload including sequential keyframes arranged by tile layout mapping 160 and sequence-order metadata assembled by sequence metadata association 162 to the transmission queue for retrieval by the query dispatch module 108. The composite tiled image payload substitutes a single API query transmission for what would otherwise require multiple separate API query transmissions for each sequential keyframe, reducing the number of outbound API calls, the total token count transmitted per event interval, and aggregate round-trip latency compared to issuing individual queries for each frame in the ordered frame set 158.

Composite payload emission 164 supports temporal interpretation of behavior transitions by delivering an ordered visual sequence to the remote artificial intelligence model within a single structured query. Analyzing a sequence of frames within a single query enables the remote artificial intelligence model to classify behavioral progressions, such as the transition from entry to loitering to approach of a restricted area, that are not reliably detectable from a single still frame. This temporal context capability reduces misclassifications that result from evaluating an event at a single ambiguous moment in the event sequence.

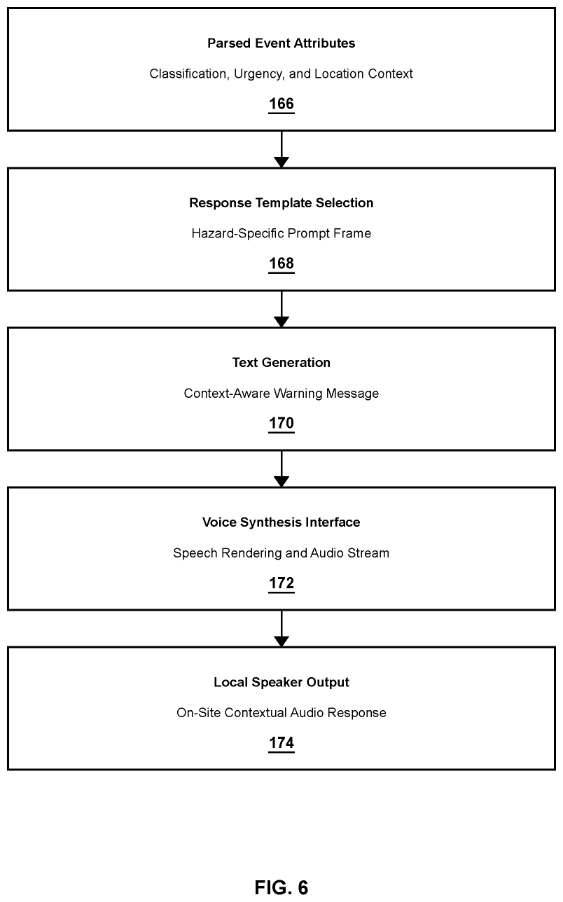

In FIG. 6, parsed event attributes 166 include classification values, severity values, and scene descriptor values extracted from the structured response fields returned by the second remote artificial intelligence model through high-detail model invocation path 154. Parsed event attributes 166 are produced by the escalation module and response parser 112 when the named field values in the second model response are parsed, and include the event classification field value, subject descriptor fields specifying observed visual characteristics of detected subjects, behavioral classification fields, and zone identifier fields specifying the monitored area in which the qualifying event occurred.

Response template selection 168 maps parsed event attributes 166 to policy-controlled response templates configured by system administrators. Each response template specifies the response actions to be executed for a given combination of event classification and zone identifier values, including whether to generate contextual speech text, whether to publish an event message to an external event bus, Response template selection 168 allows organizations to configure differentiated response behavior for distinct monitoring zones and event classification levels without modifying the underlying processing pipeline.

Text generation 170 synthesizes contextual speech text from parsed response fields selected from the parsed event attributes 166 according to the template selected by response template selection 168. The contextual speech text generated by text generation 170 references observed visual attributes from the second model response, including subject clothing descriptors, object descriptors, and behavioral descriptors, to produce a personalized verbal notification that describes the subject's observed appearance and directs the subject toward a defined response action. For example, the contextual speech text generated by text generation 170 can reference specific clothing attributes and immediate actions, such as “You in the red hoodie, step away from the vehicle immediately,” producing a context-driven verbal response that makes the subject acutely aware of active, personalized monitoring and significantly improving deterrence efficacy. This specificity distinguishes the contextual speech text from static pre-recorded alert messages that convey no observed scene content and provide reduced deterrence efficacy relative to notifications that demonstrate active scene awareness.

Voice synthesis interface 172 converts the contextual speech text generated by text generation 170 into an audio output stream by transmitting the text to a voice synthesis application programming interface endpoint configured in the plurality of API feature links 118. The voice synthesis application programming interface returns synthesized speech audio data corresponding to the input text, which the automated response module 114 routes to the local speaker output 174. The voice synthesis application programming interface endpoint is one of the configurable remote service endpoints to which the query dispatch module 108 can dispatch concurrent detached threads, allowing voice synthesis to execute in parallel with other configured response actions.

Local speaker output 174 renders the synthesized audio output stream to on-site listeners through a speaker connected to the camera device 100. The automated response module 114 delivers the audio output stream to the local audio output interface of the camera device 100 within milliseconds of receiving the parsed structured response record from the response data structure, enabling the verbal notification to be executed while the qualifying event condition is still present in the monitored scene. The combination of event-correlated execution timing and contextually specific speech content produces a deterrence response that is functionally distinct from delayed, generic alert notifications.

The automated response module 114 can combine local audio output through local speaker output 174, external event publication through external event and data systems 120, and remote notification dispatch pathways for coordinated response execution within a single event processing cycle. The automated response module 114 governs repeated audio response behavior during sustained event intervals, maintaining audio output intelligibility during extended qualifying events.

The architecture supports interoperable event protocol publication through external event and data systems 120 and supports local speech response execution through voice synthesis interface 172 and local speaker output 174 while preserving structured event classification records.

The architecture supports region-conditioned compression workflows in which event-indicated region of interest 140, optional multi-region selection 144, and compressed payload output 146 are generated before queue transfer and remote model interaction. The architecture supports temporal sequencing workflows in which ordered frame set 158, tile layout mapping 160, sequence metadata association 162, and composite payload emission 164 provide event progression context for remote classification pathways.

The architecture supports hierarchical cost control workflows in which low-cost first-pass model stage 148, gate output state 150, escalation decision branch 152, and high-detail model invocation path 154 limit high-cost model invocation to qualified events. The architecture also supports rule-update feedback workflows in which structured artificial intelligence output parsing step 134 writes rule-store records consumed by edge event listener 104 before subsequent trigger criteria evaluation step 124 cycles. The architecture supports deterministic mapping from structured response fields to structured response records, event-classification records, and response pathways managed by automated response module 114 for consistent deployment behavior across camera fleets.

A person of ordinary skill in the art can implement the disclosed architecture using camera firmware pathways that subscribe to ASIC kernel metadata events, edge software modules that perform keyframe extraction, bounding-box-informed adaptive compression, and query dispatch, and remote model interfaces that return machine-parseable structured responses, while preserving the module and dataflow relationships described in FIG. 1 through FIG. 6.

In one example deployment using camera device 100 and built-in sensor subsystem 102, kernel metadata events can include event-class tags, coordinate outputs, and timestamp fields supporting deterministic event ordering. Edge event listener 104 can consume event records in arrival order and can apply trigger criteria evaluation using schedule windows, zone constraints, and persistence thresholds. Keyframe extraction module and adaptive compression module 106 can align keyframe selection windows to event timestamps so keyframe records preserve pre-event context, event context, and post-event context for remote analysis workflows.

In another example deployment using query dispatch module 108 and plurality of API feature links 118, structured prompt payloads can include event identifiers, location descriptors, requested output schema fields, and sequence-order metadata references. Query dispatch module 108 can format first query messages and second query messages for endpoint-specific requirements while preserving normalized field mapping for escalation module and response parser 112. Plurality of API feature links 118 can support endpoint routing policies separating low-cost gate workloads from high-detail escalation workloads represented by low-cost first-pass model stage 148 and high-detail model invocation path 154.

In yet another example deployment using escalation module and response parser 112 and merged structured output handling element 156, gate output state 150 can route event processing to escalation decision branch 152 when first-pass response fields satisfy escalation thresholds. Escalation module and response parser 112 can preserve first-pass response fields and second-pass response fields in normalized record sets including source-model identifiers, confidence values, and classification values. Escalation module and response parser 112 can write structured response records with event-classification fields and can write escalation marker values associated with event identifiers for audit pathways.

In one example deployment using keyframe extraction module and adaptive compression module 106, region-of-interest crop and adaptive compression step 128 can consume bounding-box coordinates from kernel metadata events and can derive event-indicated region of interest 140 and optional multi-region selection 144 before encoding. Keyframe extraction module and adaptive compression module 106 can generate compressed payload output 146 from cropped regions for bandwidth reduction while preserving event evidence. Composite payload emission 164 can generate tiled payloads from ordered frame set 158 when event timing patterns benefit from temporal sequence interpretation by remote model pathways.

In one example deployment using structured artificial intelligence output parsing step 134 and automated event or audio response execution step 136, escalation module and response parser 112 can enforce schema validation before writing structured response records to a response data structure. Structured artificial intelligence output parsing step 134 can reject malformed field sets and can write structured diagnostics for nonconforming response payloads. Automated response module 114 can consume validated structured response records, map validated structured response records to response template selection 168, and execute event publication pathways through external event and data systems 120 and local audio pathways through voice synthesis interface 172 and local speaker output 174.

In another deployment using feedback pathways, structured artificial intelligence output parsing step 134 can write a feedback record to a rule store, and edge event listener 104 can read the feedback record from the rule store before subsequent trigger criteria evaluation step 124 cycles. Feedback records can include false-positive indicators, event-class corrections, and threshold adjustment directives generated from action review pathways. Edge event listener 104 can apply feedback-driven trigger criteria updates to reduce recurring non-actionable event qualification while preserving event capture behavior for high-priority classifications represented in structured response records.

In yet another example deployment using external sensors 116, edge event listener 104 can fuse kernel metadata events with contextual signals from external sensors 116 during trigger criteria evaluation step 124. External sensor values can include environmental sensor values such as temperature, ambient light level, and humidity readings, and auxiliary detection values such as perimeter state signals from door and window sensors and acoustic event outputs from audio detection devices. Trigger criteria can require concurrent qualification of kernel metadata event type and contextual state. Keyframe extraction module and adaptive compression module 106 can consume qualified event identifiers from edge event listener 104 and can generate queue payloads for qualified event identifiers to reduce unnecessary upstream transfer volume.

In an example deployment using event publication pathways, automated response module 114 can publish event messages including event classification, escalation status, and event identifier values to external event and data systems 120 using interoperable event protocol formatting. External event and data systems 120 can receive normalized records for dashboard rendering, archival storage, and downstream orchestration. Automated response module 114 can synchronize event publication timing with local speaker output 174 timing so local intervention pathways and remote monitoring pathways receive consistent classification results for a single event identifier.

In an example deployment using audio response pathways, response template selection 168 can map parsed event attributes 166 to policy templates associated with event classification and zone context. Text generation 170 can generate contextual speech text aligned to selected policy templates. Voice synthesis interface 172 can convert generated text to an audio output stream for local speaker output 174. Automated response module 114 governs audio output through local speaker output 174 to maintain intelligibility during sustained event intervals.

In one example deployment using concurrent query pathways, query dispatch module 108 can transmit detached query threads concurrently to a plurality of remote artificial intelligence models and can track per-thread response identifiers for structured merge handling by escalation module and response parser 112. Merged structured output handling element 156 can reconcile asynchronous thread return ordering by event identifier and sequence-order metadata fields from sequence metadata association 162. Escalation module and response parser 112 can write a unified structured response record after reconciliation so automated response module 114 executes a single coordinated response path for an event interval.

In a deployment using security controls, the query dispatch module 108 and the plurality of API feature links 118 can support endpoint authentication profiles including Open Authorization (OAuth) and API-key pathways. Query dispatch module 108 can maintain endpoint-specific credential references and can apply credential references during first query message dispatch and second query message dispatch workflows. Response parser 112 can log endpoint response status values and credential profile identifiers in diagnostics records associated with event identifiers for operational audit and troubleshooting pathways.

Operationally, camera device 100, built-in sensor subsystem 102, edge event listener 104, keyframe extraction module and adaptive compression module 106, query dispatch module 108, escalation module and response parser 112, automated response module 114, and external event and data systems 120 provide an end-to-end event-conditioned analysis and action architecture reducing broad stream transfer, prioritizing high-value escalation pathways, and executing deterministic machine-actionable responses grounded in structured remote model outputs.

In certain embodiments, the agentic application resident in the camera device 100 comprises an object and event detection module 176 and an event generation module 178. The object and event detection module 176 interfaces with external artificial intelligence services via artificial intelligence (AI) application programming interface (API) endpoints to identify, with granularity, objects and events detected in the camera view or live stream. The event generation module 178 generates events based on objects or events detected by the object and event detection module 176.

The object and event detection module 176 is configured to detect any object, person, structure, or item captured within the camera view, including but not limited to persons, vehicles, license plates, animals, and handheld objects. The module applies detection criteria including size, shape, and movement patterns to classify detected objects. Context-sensitive classification by the object and event detection module 176, in conjunction with external artificial intelligence services, distinguishes between objects that are benign and objects that constitute a threat. A stick lying on a surface, for example, is classified differently from a stick being brandished by a person exhibiting aggressive behavior. When the object and event detection module 176 identifies a weapon, such as a firearm, the event generation module 178 encodes the bounding-box coordinates and associated metadata as an overlay onto the video stream, labeling the weapon within the frame to attract the operator's attention. A user can also input search terms or object descriptors, such as the word “gun,” through the user interface module, and the object and event detection module 176 identifies and highlights matching objects within the live video stream.

The object and event detection module 176 is further configured to detect whether a person is struggling or in distress, as distinguished from ordinary movement, by submitting keyframe images to external artificial intelligence services for contextual analysis. For example, when monitoring a swimming pool, the object and event detection module 176 in conjunction with external artificial intelligence services can distinguish between a person playing in the pool and a person who is struggling or drowning, escalating the latter condition. When the object and event detection module 176 determines that a detected condition warrants escalation, it passes the determination to the event generation module 178 for response execution. When the object and event detection module 176 determines that the detected condition does not warrant escalation, no alert is generated and processing returns to the event monitoring loop.

In certain embodiments, the agentic application supports cloud-based facial recognition integrated with the object and event detection module 176. Upon detection of a person, the object and event detection module 176 submits keyframe image data to external artificial intelligence services to perform facial recognition and generate detailed overlay data, which the object and event detection module 176 encodes as overlay data onto the video stream. Overlay data generated by the facial recognition process and written to the overlay data can include an identified person's name, age, gender, race, descriptive attributes such as apparent demeanor, whether the person is wearing a mask or obscuring their face, clothing type and color, and any objects carried by or on the person, including weapons, badges, or other identifying items.

The event generation module 178 is configured to receive facial recognition overlay data and encode bounding-box coordinates and overlay metadata as overlays onto the video stream, associating overlay data with the detected object or person within the frame. When a named individual is identified, the event generation module 178 reads the identification attributes from the overlay data and encodes the person's name adjacent to the person's position in the stream so that the association persists across frames in which the person appears. For example, when an identified individual named Bill appears in the video stream, the event generation module 178 encodes Bill's name in an overlay data box that tracks with Bill's position across successive frames, along with associated attribute data such as descriptive attributes such as apparent demeanor and clothing descriptors. The event generation module 178 is further configured to encode classification data, including observed behavioral attributes read from the overlay data, onto the stream for downstream consumption and storage.

The event generation module 178 is configured to support two-way audio communication through integrated microphones and speakers resident in or coupled to the camera device 100. The event generation module 178 enables live talkdowns and interactive verbal responses via text-to-speech conversion based on the agentic application's observation of objects or events detected in the camera view. The event generation module 178 converts artificial intelligence-generated text responses into audio output using text-to-speech technology and streams synchronized audio to on-site or network-connected speakers.

In certain embodiments, the agentic application is configured to automatically supply emergency response operators, including Enhanced 911 (E911) operators, with information derived from detected events. When an emergency or criminal event is detected, the agentic application, in conjunction with external artificial intelligence services, identifies and packages the most operationally relevant details for emergency or law enforcement personnel. The agentic application selects and extracts relevant keyframes from the video stream and uses external artificial intelligence services to identify event-specific attributes including the physical address of the deployment location and identifying characteristics of subjects involved in the event, such as weight, approximate age, hair color, eye color, gender, race, and clothing. For example, in an active shooter scenario at a school, the agentic application can identify the address of the school and provide identifying characteristics of the shooter to E911 operators or law enforcement personnel in real time.

The agentic application is further configured to act as a network conduit that facilitates communication between the camera device 100 and any other device coupled to the network. Upon detection and analysis of an event, the agentic application can parse artificial intelligence-generated structured responses formatted in JavaScript Object Notation (JSON) and convert the parsed results into Extensible Markup Language (XML)-formatted event messages for transmission to downstream network devices. Using these event messages, the agentic application can cause the camera device 100 to trigger hardware actions on connected systems, including locking or unlocking access control devices, sounding local or networked alarms, and initiating contact with emergency or law enforcement personnel to report crimes or emergencies in progress.

In certain embodiments, the agentic application monitors for compliance conditions within the camera view. When workers or personnel within the camera view are expected to wear personal protective equipment, including hard hats or safety gear, the object and event detection module 176 detects and flags instances of noncompliance. Detected noncompliance events are reported to designated users or encoded into the camera stream for subsequent review and audit.

In certain embodiments, the agentic application monitors for contextual change conditions that are not limited to object or person detection. For example, the object and event detection module 176 can detect when an indicator light or status display within the camera view transitions between predefined states, and the event generation module 178 generates an alert or escalation in response. In another example, the object and event detection module 176 can monitor a property and detect when an unauthorized person is attempting to siphon a well or tamper with equipment, alerting the property owner through the event generation module 178. The agentic application can be configured to detect any contextual change visible within the camera view and to generate an intelligently escalated alert to a user, external system, or other network-connected device.

A user interface module executable by the processor of the camera device 100 provides graphical user interfaces through which users interact with the agentic application and the camera device 100. The user interface module allows users to configure object detection criteria, specify trigger conditions, review overlay data, and interact with detected events in real time. In certain embodiments, a user can input search terms or object descriptors through the user interface module, and the agentic application will identify and highlight matching objects within the live video stream.

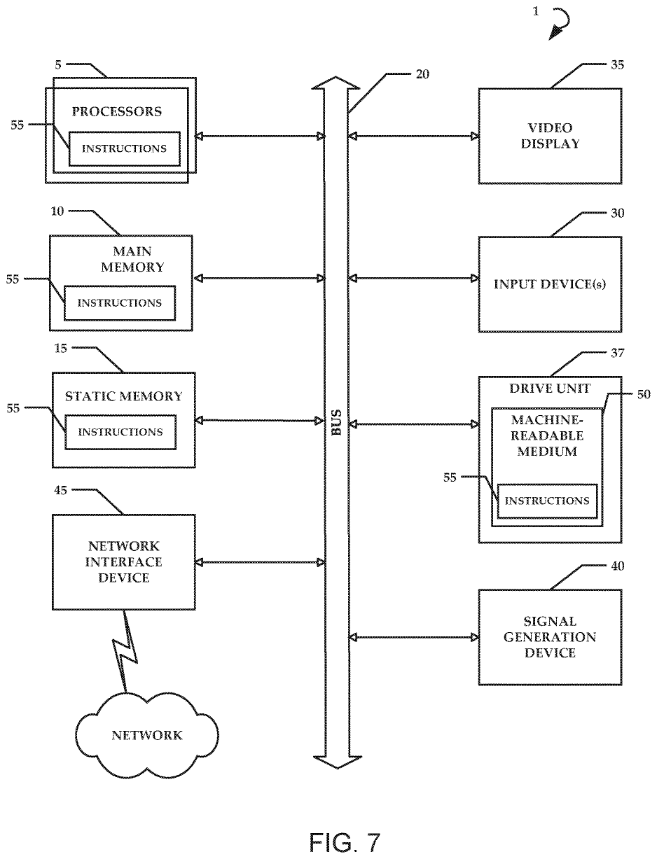

FIG. 7 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. These are considered “endpoints” of a system. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1 includes a processor or multiple processor(s) 5 (e.g., a central processing unit (CPU), a graphics processing unit (GPU), a neural processing unit (NPU), or any combination thereof), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

Where appropriate, the functions described herein can be performed in one or more of hardware, software, firmware, digital components, or analog components. For example, the encoding and or decoding systems can be embodied as one or more application specific integrated circuits (ASICs) or microcontrollers that can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

What is claimed is:

1. A system comprising:
a camera device including a built-in sensor subsystem configured to generate kernel metadata events and a video stream;
an edge event listener resident in the camera device and configured to read the kernel metadata events from an event buffer;
a keyframe extraction module resident in the camera device and configured to read video frames from the video stream and write keyframe records to a keyframe buffer responsive to the kernel metadata events satisfying trigger criteria;
an adaptive compression module resident in the camera device and configured to read the keyframe records and bounding-box coordinates included in the kernel metadata events and write compressed image payloads to a transmission queue;
a query dispatch module configured to read the compressed image payloads and structured prompt payloads from the transmission queue and transmit first query messages to a first remote artificial intelligence model through a network interface;
an escalation module configured to parse first model responses and, when a gate field selected from 0 and 1 is 1, transmit second query messages to a second remote artificial intelligence model;
a response parser configured to parse second model responses and write structured response records including event-classification fields to a response data structure; and
an automated response module configured to read the structured response records from the response data structure and execute output actions.

2. The system of claim 1, wherein the adaptive compression module is configured to crop a region of interest based on the bounding-box coordinates before writing the compressed image payloads to the transmission queue.

3. The system of claim 1, wherein the adaptive compression module is configured to write a composite tiled image payload including sequential keyframes and sequence-order metadata to the transmission queue.

4. The system of claim 1, wherein the query dispatch module is configured to transmit detached query threads concurrently to a plurality of remote artificial intelligence models.

5. The system of claim 1, wherein the response parser is configured to write a feedback record to a rule store and the edge event listener is configured to read the feedback record from the rule store to update the trigger criteria.

6. The system of claim 1, wherein the automated response module is configured to publish an event message including an event classification to an external event bus using an interoperable event protocol.

7. The system of claim 1, wherein the automated response module is configured to synthesize contextual speech text from parsed response fields and transmit an audio output stream to a local audio output interface.

8. A method comprising:
receiving, by an edge event listener resident in a camera device, kernel metadata events from a built-in sensor subsystem into an event buffer;
reading, by a keyframe extraction module resident in the camera device, video frames from a video stream and writing keyframe records to a keyframe buffer responsive to the kernel metadata events satisfying trigger criteria;
reading, by an adaptive compression module resident in the camera device, the keyframe records and bounding-box coordinates included in the kernel metadata events and writing compressed image payloads to a transmission queue;
reading, by a query dispatch module, the compressed image payloads and structured prompt payloads from the transmission queue and transmitting first query messages to a first remote artificial intelligence model through a network interface;
receiving, by an escalation module, first model responses including a gate field selected from 0 and 1 and transmitting second query messages to a second remote artificial intelligence model when the gate field is 1;
parsing, by a response parser, second model responses and writing structured response records including event-classification fields to a response data structure; and
reading, by an automated response module, the structured response records from the response data structure and executing output actions.

9. The method of claim 8, wherein writing the compressed image payloads includes cropping a region of interest based on the bounding-box coordinates before writing the compressed image payloads to the transmission queue.

10. The method of claim 8, wherein writing the compressed image payloads includes writing a composite tiled image payload including sequential keyframes and sequence-order metadata to the transmission queue.

11. The method of claim 8, wherein transmitting the first query messages includes transmitting detached query threads concurrently to a plurality of remote artificial intelligence models.

12. The method of claim 8, further comprising writing, by the response parser, a feedback record to a rule store and reading, by the edge event listener, the feedback record from the rule store to update the trigger criteria.

13. The method of claim 8, wherein executing the output actions includes publishing an event message including an event classification to an external event bus using an interoperable event protocol.

14. The method of claim 8, wherein executing the output actions includes synthesizing contextual speech text from parsed response fields and transmitting an audio output stream to a local audio output interface.

15. A video surveillance system comprising:
a camera device including a built-in sensor subsystem configured to generate kernel metadata events and a video stream;
an edge event listener resident in the camera device and configured to read the kernel metadata events from an event buffer;
an object and event detection module resident in the camera device and configured to interface with one or more external artificial intelligence services to detect and classify objects and events in the video stream using image data submitted to the one or more external artificial intelligence services;
a keyframe extraction and adaptive compression module resident in the camera device and configured to read video frames from the video stream, write keyframe records to a keyframe buffer responsive to the kernel metadata events satisfying trigger criteria, and read the keyframe records and bounding-box coordinates included in the kernel metadata events and write compressed image payloads to a transmission queue;
a query dispatch module configured to read the compressed image payloads and structured prompt payloads from the transmission queue and transmit first query messages to a first remote artificial intelligence model through a network interface;
an escalation module configured to parse first model responses including a gate field selected from 0 and 1 and transmit second query messages to a second remote artificial intelligence model when the gate field is 1;
a response parser configured to parse second model responses and write structured response records including event-classification fields to a response data structure; and
an event generation module configured to read the structured response records from the response data structure and generate events including encoding overlay metadata onto the video stream and transmitting structured event messages through the network interface to one or more downstream network-connected devices.

16. The video surveillance system of claim 15, wherein the object and event detection module is further configured to perform cloud-based facial recognition on image data submitted to the one or more external artificial intelligence services and generate facial recognition overlay data including identification attributes.

17. The video surveillance system of claim 16, wherein the event generation module is further configured to read the facial recognition overlay data and encode the identification attributes as overlays associated with identified persons in the video stream.

18. The video surveillance system of claim 15, wherein the structured event messages transmitted by the event generation module are formatted in a machine-parseable structured format and include event-classification fields derived from the structured response records written by the response parser.

19. The video surveillance system of claim 15, wherein the event generation module is further configured to synthesize contextual speech text from the event-classification fields read from the response data structure and transmit an audio output stream referencing observed visual attributes to a local audio output interface.

20. The video surveillance system of claim 15, wherein the event generation module is further configured to transmit a trigger signal through the network interface to at least one of an access control device and an alarm system in response to reading a structured response record including an event-classification field exceeding a predefined threshold from the response data structure.
